(19) United States
(12) Patent Application Publication
(10) Pub. No.: US 2026/0222321 A1
(43) Pub. Date: Jul. 30, 2026

(54) NOTIFICATION TRANSMISSIONS FOR ALERTS

(71) Applicant: PagerDuty, Inc., San Francisco, CA (US)

(72) Inventors: Girish Shankarraman, Kirkland, WA (US); Zach Renaud, Ottawa (CA)

(21) Appl. No.: 19/041,366

(22) Filed: Jan. 30, 2025

(51) Int. Cl. H04L 41/5009; H04L 41/06

(52) U.S. Cl. CPC H04L 41/5009; H04L 41/06

(57) ABSTRACT

An operations management system determines, based on historical notification metrics, a set of transmission ratings for each communication technology of a plurality of communication technologies. The operations management system determines, based on the set of transmission ratings for each communication technology of the plurality of communication technologies, a score for each communication technology of the plurality of communication technologies. The operations management system selects, based on the score for each communication technology of the plurality of communication technologies, one or more communication technologies from the plurality of communication technologies. The operations management system generates, based on the one or more selected communication technologies, a notification for an alert. The operations management system transmits, based on the one or more communication technologies, the notification to the customer system.

### TECHNICAL FIELD

This disclosure relates generally to computer networking, and, more specifically, managing alerts.

### BACKGROUND

Operations computing systems may evaluate events from one or more customer systems to determine which events should be classified as alerts. Operations computing systems may prompt on-call responders and/or stakeholders (e.g., through one or more notifications) to address operations events connected to a customer system from which an alert may have originated. To transmit notifications, the computing system may have the functionality to communicate over multiple communication technologies, such as SMS, email, or RCS (e.g., through one or more messaging applications, such as WhatsApp or iMessage, or transmitted over the Internet, such as a mobile network or WIFI). Similarly, responders and/or stakeholders may have their own notification rulesets that function as a set of preferences and/or limitations on how a given responder may receive notifications from the operations computing system (e.g., being unable to receive SMS, preferring email to RCS, etc.).

Aspects of the present disclosure describe techniques for dynamically transmitting notifications over a selected communication technology from a plurality of communication technologies. A communication technology may include any technical messaging technology and/or interface (e.g., application, communication protocol, etc.) by which a computing device may receive and/or interact with a notification from the operations computing system. For instance, a communication technology may include Short Message Service (SMS) (e.g., text messages), Rich Communication Service (RCS), e-mail, voice-based services (e.g., voice over IP, cellular, etc.), webhooks, or Internet Relay Chat (IRC). A communication technology may also include applications (e.g., WhatsApp, iMessages, Google Messages, Facebook Messenger, Microsoft Teams, Slack, custom applications, etc.) on a computing device (e.g., cellular phone, laptop, desktop, tablet, etc.) that are capable of receiving and displaying notifications directly or through one or more APIs.

In general, an operations computing system may determine, based on historical notification metrics, a set of transmission ratings for each communication technology of a plurality of communication technologies. The historical notification metrics may include respective notification metrics associated with one or more previous notifications transmitted to a customer system using one communication technology from the plurality of communication technologies. For example, the operations computing system may analyze information associated with three previous notifications transmitted over a communication technology to determine that two notifications were successfully transmitted and took 1.3 seconds and 1.9 seconds, respectively, to be received by the customer system, while the third notification was not successfully received. The operations computing system may determine transmission ratings, such as an average speed of 1.6 seconds or a success rate (e.g., the number of notifications successfully received by customer systems to the number of notifications a customer system failed to receive) of 66%.

The operations computing system may determine a score for each communication technology in the plurality of communication technologies based on the set of transmission ratings for each communication technology of the plurality of communication technologies. For example, the operations computing system may determine, based on a respective set of transmission ratings such as average delivery speed or success rate, a score for a communication technology indicating a relative performance associated with transmitting notifications to a customer system using the communication technology compared to other communication technologies.

The operations computing system may select one or more communication technologies from the plurality of communication technologies based on the score for each communication technology of the plurality of communication technologies. For example, the operations computing system may select one or more highly scored communication technologies in the plurality of communication technologies. The operations computing system may, for instance, transmit a notification to a customer system using the selected one or more highly scored communication technologies. By transmitting notifications using a communication technology selected based on transmission metrics, the operations computing system may improve success rates, integrity of notification content, and/or transmission speeds associated with sending responders notifications related to an alert on a customer computing system. In this way, the operations computing system may efficiently and reliably transmit notifications to responders to reduce downtime associated with responding to disruptions to impacted services and systems.

In one example, this disclosure is directed to a method comprising determining, by an operations management system and based on historical notification metrics, a set of transmission ratings for each communication technology of a plurality of communication technologies, wherein the historical notification metrics include respective notification metrics associated with one or more previous notifications transmitted to a customer system, and wherein each of the one or more previous notifications was transmitted to the customer system using one communication technology from the plurality of communication technologies; determining, by the operations management system and based on the set of transmission ratings for each communication technology of the plurality of communication technologies, a score for each communication technology of the plurality of communication technologies; selecting, by the operations management system and based on the score for each communication technology of the plurality of communication technologies, one or more communication technologies from the plurality of communication technologies; generating, by the operations management system and based on the one or more selected communication technologies, a notification for an alert associated with the customer system; and transmitting, by the operations management system and based on the one or more communication technologies, the notification to the customer system.

In another example, this disclosure is directed to a system comprising a memory and one or more processors having access to the memory. The one or more processors are configured to determine, based on historical notification metrics, a set of transmission ratings for each communication technology of a plurality of communication technologies, wherein the historical notification metrics include respective notification metrics associated with one or more previous notifications transmitted to a customer system, and wherein each of the one or more previous notifications was transmitted to the customer system using one communication technology from the plurality of communication technologies; determine, based on the set of transmission ratings for each communication technology of the plurality of communication technologies, a score for each communication technology of the plurality of communication technologies; select, based on the score for each communication technology of the plurality of communication technologies, one or more communication technologies from the plurality of communication technologies; generate, based on the one or more selected communication technologies, a notification for an alert associated with the customer system; and transmit, based on the one or more communication technologies, the notification to a customer system.

In an additional example, this disclosure is directed to a non-transitory computer-readable storage medium encoded with instructions that, when executed, cause at least one processor of a computing system to determine, based on historical notification metrics, a set of transmission ratings for each communication technology of a plurality of communication technologies, wherein the historical notification metrics include respective notification metrics associated with one or more previous notifications transmitted to a customer system, and wherein each of the one or more previous notifications was transmitted to the customer system using one communication technology from the plurality of communication technologies; determine, based on the set of transmission ratings for each communication technology of the plurality of communication technologies, a score for each communication technology of the plurality of communication technologies; select, based on the score for each communication technology of the plurality of communication technologies, one or more communication technologies from the plurality of communication technologies; generate, based on the one or more selected communication technologies, a notification for an alert associated with the customer system; and transmit, based on the one or more communication technologies, the notification to a customer system.

The details of one or more examples of the disclosure are set forth in the accompanying drawings and the description herein. Other features, objects, and advantages of the disclosure will be apparent from the description and drawings, and from the claims.

### BRIEF DESCRIPTION OF DRAWINGS

FIG. 1 is a block diagram illustrating an example system including an operations computing system configured to determine a communication technology to use to transmit a notification to a customer system, in accordance with one or more aspects of the present disclosure.

FIG. 2 is a block diagram illustrating an example operations computing system, in accordance with one or more aspects of the present disclosure.

FIG. 3 is a flow diagram illustrating example operations of dynamically transmitting one or more notifications to a customer system, in accordance with one or more techniques of this disclosure.

### DETAILED DESCRIPTION

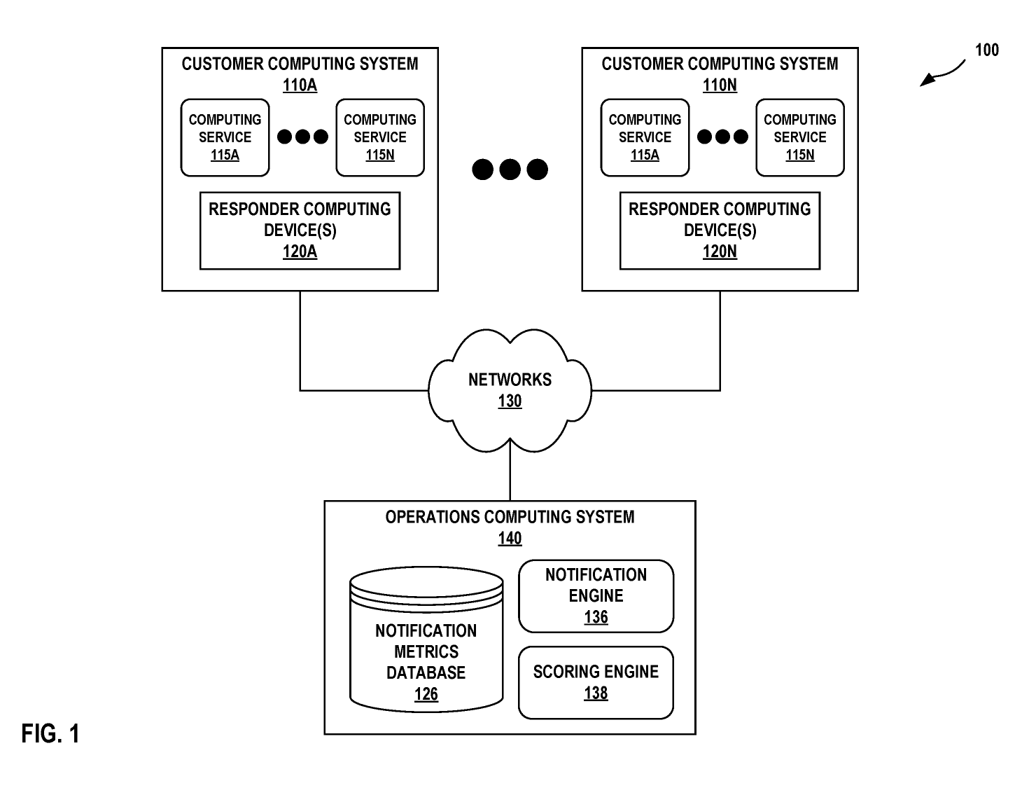

FIG. 1 is a block diagram illustrating example system 100 including operations computing system 140 configured to determine a communication technology to use to transmit a notification to a customer system, in accordance with one or more aspects of the present disclosure. A notification is generally defined as a message to one or more responders associated with a customer system that provides information on one or more alerts.

System 100, in the example of FIG. 1, may include operations computing system 140, customer computing systems 110A–110N (collectively, “customer computing systems 110”), and networks 130. A number of devices and/or systems are shown connected to networks 130 in FIG. 1. Such devices and systems include operations computing system 140 and customer computing systems 110A-130N. Operations computing system 140 may use networks 130 to receive one or more indications of an operations event (e.g., data associated with service degradations, security vulnerabilities, service availability, permissions, resource availability, etc.) from customer computing systems 110, which various cloud-based service providers may host. In response, operations computing system 140 may determine an alert for the one or more operations event. Operations computing system 110 may generate a notification and may use networks 130 to transmit the notification to customer computing systems 110. In some examples, components of operations computing system 140 may be located in a geographically disparate location in order to provide high-speed services to customer computing systems 110 in the same geographic location.

Networks 130 illustrated in FIG. 1 may include or represent any public or private communications network or other network. One or more client devices, server devices, or other devices may transmit and receive data, commands, control signals, and/or other information across such networks using any suitable communication techniques. In some examples, networks 130 may be a separate network as illustrated in FIG. 1 or may be a subnetwork of another network. In other examples, Further, one or more of such networks may be, or may be part of, the internet. Accordingly, one or more of the devices or systems illustrated in FIG. 1 may be in a remote location relative to one or more other illustrated devices or systems. Networks 130 illustrated in FIG. 1 may include one or more network hubs, network switches, network routers, network links, satellite dishes, telecommunication infrastructure equipment, or any other network equipment. Such devices or components may be operatively inter-coupled, thereby providing for the exchange of information between computers, devices, or other components (e.g., between one or more user devices or systems and one or more server devices or systems).

Customer computing systems 110 may communicate with external computing systems, such as operations computing system 140, over networks 130. Customer computing systems 110 may be computing systems administered by a large organization, such as a financial institution, bank, medical facility, or other type of large organization, which may commonly rely on significant computing resources. As illustrated in FIG. 1, customer computing systems 110 may include computing services 115A-115N (collectively, “computing services 115”) and responder computing devices 120A-120N (collectively, “responder computing devices 120”). Computing services 115 may be any technical software or hardware component (or combination therein) hosted on and/or managed by customer computing systems 110. For instance, computing services 115 may include scripts, automated tools, applications, computing devices and/or systems, microservices, and other technical components. For instance, in one example, computing service 115A may be a database. In another example, computing service 115B may be a web application. In another example, computing services 115C may be a server (e.g., cloud server, virtual server, etc.).

Customer computing systems 110 may communicate with operations computing system 140 to create and/or transmit information related to one or more operations events that occur on customer computing systems 110. Operations computing system 140 may use the information related to the operations events to determine an alert. An alert may represent an indication of an operation event (e.g., state of change) to customer computing systems 110. For instance, operations computing system 140 may determine an alert in response to receiving an indication (e.g., from customer computing system 110A) of a security issue (e.g., security threat, security vulnerability, etc.). In another example, operations computing system 140 may determine an alert in response to operations computing system 140 and/or customer computing system 110B making one or more resources (e.g., files, systems, web applications, etc.) available to one or more of responder computing devices 140B. In another examples, operations computing system 140 may determine an alert in response to a negative state of change to one of computing services 115 of customer computing system 110C (e.g., a non-marginal level of impact such as the degradation of a service). An event may trigger (e.g., may be, may be classified as, may be converted into, etc.) an alert.

In some examples, when multiple alerts arise for the same operations event, operations computing system 140 may aggregate the alerts into a single alert grouping (e.g., to centralize critical information). For instance, in one example, computing services 115A may encounter multiple errors related to its inability to store information in one or more databases. In response to receiving multiple messages from the associated customer computing system, and in turn creating multiple alerts, operations computing system 140 may aggregate the multiple alerts into a centralized alert grouping.

An individual alert may include various factors used to evaluate or otherwise describe the alert. For instance, an alert may include information related to the priority status of the alert (e.g., to assist responders assigned to multiple alerts in determining the order in which each alert should be addressed). An alert may include information related to the urgency of the alert (e.g., how quick the alert may need to be addressed, etc.). An alert may include information related to the severity of the alert (e.g., whether the importance of the operations event is low, such as a warning to one of computing services 115, or high, such as critical errors, security vulnerabilities, etc.).

In some examples, any of customer computing systems 110, or components within, may directly report information to operations computing system 140 (e.g., to determine an alert) through one or more integrations (e.g., API interactions). For instance, in one example, computing services 115A of customer computing system 110A may have one or more software integrations that are configured to report information related to operations events to operations computing system 140 in the event of a state of change to computing service 115A. In other examples, customer computing systems 110 may use third-party tools and/or services, such as a monitoring service, to monitor one or more of computing services 115 and report status changes within a monitored service (e.g., any of computing services 115) to operations computing system 140. For instance, customer computing systems 110B may have a monitoring service configured to monitor resource availability to one or more responders. The monitoring service may transmit information to operations computing system 140 in response to an operations event, such as a change in access to the resources (e.g., a resource being made available to responder computing device 120B).

Responder computing devices 120 may be devices that are used by one or more on-call responders of customer computing systems 110. An on-call responder may be an employee of an organization associated with any customer computing systems 110 that is contacted upon the determination of one or more alerts (e.g., via a notification informing the responder to investigate and/or fix issues, providing information related to one or more time-sensitive and/or critical operations of any of customer computing systems 110, etc.). Responder computing devices 120 may represent standard devices that are utilized by one or more employees of an organization associated with customer computing systems 110. For instance, in one example, one of responder computing devices 120A may be a laptop computer utilized by one on-call responder. In another example, one of responder computing devices 120A may be a desktop computer utilized by a manager of the organization associated with customer computing system 110A. In another example, one of responder computing devices 120A may be a cellular device (e.g., a smart phone) utilized by another on-call responder. Responder computing devices 120 may be used to interact with other systems, devices, and components across networks 130.

A notification ruleset may be associated with any of responder computing devices 120. A notification ruleset may determine how a responder (e.g., the responder associated with any of responder computing devices 120) may be notified when an alert is assigned or otherwise associated with them. For instance, a notification ruleset may comprise rules about the frequency at which a responder may be notified at, which communication technologies may transmit one or more notifications, and which communication technologies may be preferred (with respect to one or more other communication technologies). In some instances, a notification ruleset may allow the responder to set one or more rules that dynamically alter one or more other rules based on the urgency or severity of an alert associated with a notification.

Operations computing system 140, in conjunction with components such as notification engine 136, may create and transmit one or more notifications to one or more responders associated with a customer computing system (e.g., any of customer computing systems 110) in response to the creation of an alert associated with the customer computing system. A notification may function as a message to one or more of responder computing devices 120 to provide information on a created alert. For instance, notification engine 136 may create a notification to include information associated with an alert, such as a unique identifier associated with the alert, status updates related to the alert (e.g., from operations computing system 140, from one or more of responder computing devices 120, etc.), the responders associated with the alert, an urgency level for the alert, or information related to the one or more operations events that caused the alert (e.g., a degradation event on one or more of computing services 115, a security vulnerability on one of customer computing systems 110, etc.). The notification may provide or operate as an interface for responders associated with the alert to interact with the alert (e.g., to update the alert with the current knowledge of the responder, to indicate that the responder is aware of the alert, to request the alert be shared with additional responders, etc.). In general, operations computing system 140 may have the functionality to transmit notifications to on-call responders over multiple communication technologies, such as SMS, email, voice, or RCS (e.g., through one or more messaging applications, such as WhatsApp or iMessage, transmitted over the Internet, such as a mobile network or WIFI).

In some systems, a notification delivery system may transmit notifications for alerts according to manually configured and/or outdated notification routing rules received from a customer system. For example, a notification delivery system may transmit a notification for an alert using SMS according to manual notification transmission configurations. However, in some instances, transmitting a notification for an alert according to manual or outdated notification transmission configurations may result in a low transmission success rate of the notification (e.g., due to the notification getting lost or dropped by unreliable networks, carriers, and aggregators), a low transmission speed of the notification (e.g., due to outdated technologies, low data payloads, etc.), a truncation of information or content included in the notification (e.g., potentially excluding important information related to an alert, such as identification information), security issues (e.g., lack of up-to-date encryption standards and protocols once the notification is transmitted), and/or compliance violations. These technical problems associated with transmitting notifications according to outdated, manually defined configurations may impact the transmission of the notification to a responder (e.g., increasing the time between a notification being sent and then notification being received by a responder), in turn increasing the time the responder may go without receiving time-sensitive information related to the operations of any of customer computing systems 110 (e.g., the downtime of a service or system associated with the alert, security vulnerabilities related to any of computing services 115, etc.).

Operations computing system 140, according to the techniques described herein, may select a particular communication technology, or a group thereof, from a plurality of communication technologies to transmit a notification for an alert based on scores determined for the plurality of communication technologies. In this way, operations computing system 140 may transmit a notification for an alert using a dynamically selected communication technology to improve transmission success rates, transmission speeds, notification integrity (e.g., complete content of notification is transmitted), and/or compliance associated with transmitting the notification to a responder of a customer system; thereby decreasing downtime of a service or system associated with the alert and/or generally improving a user’s experience associated with receiving notifications for alerts.

In accordance with the techniques described herein, operations computing system 140 may select a communication technology to transmit a notification to one of customer computing systems 110. Operations computing system 140, or more specifically scoring engine 138, may receive historical notification metrics from notification metrics database 126. Notification metrics database 126 may represent any suitable data structure or storage media for storing information related to notification metrics from one or more notifications transmitted to one or more of customer computing systems 110. A historical notification metric may include notification metrics associated with one or more previous notifications transmitted to any of customer computing systems 110 using one communication technology from the plurality of communication technologies. In some examples, data in notification metrics database 126 may represent a system of record associated with system 100, which may serve as an authoritative data source for at least some data pertaining to system 100, or pertaining to the operations of the business, organization, or other entity that administers network 130.

In some examples, notification metrics database 126 may contain metrics for one or more notifications. In some examples, notification metrics database 126 may contain one or more data sets and/or data structures, such as a delivery report or delivery receipt, which may in turn contain information related to metrics for a notification, such as the transmission status of the delivery of the notification (e.g., delivered, undelivered, pending, failed to deliver, etc.) or the time a responder received the notification. In some instances, a historical notification metric may include information related to the content of a notification, such as the text of the notification or included multimedia content. In some instances, a historical notification metric may include information related to one or more messages received from a responder in response to a notification. For example, a historical notification metric may include information related to a message received from a user requesting more information about the alert specified in a notification. In some instances, notification metrics database 126 may include metrics associated with communication technology performance corresponding to transmitting notifications with various content attributes (e.g., a metric mapping performance associated with an amount of content, information, or data included in a notification to a communication technology used to transmit the notification.). In some instances, notification metrics database 126 may include metrics associated with computational resources consumed by operations computing system 140 and/or any of customer computing systems 110 when transmitting notifications for alerts.

Scoring engine 138 may determine the set of transmissions ratings based in part on historical notification metrics stored at notification metrics database 126. The set of transmission ratings may include ratings such as average transmission resource usage (e.g., the average measurement of computing resources needed to transmit a notification, the average measurement of computing resources needed by a responder to receive a notification, a combination of the former and the latter, etc.), transmission success rate (e.g., the amount of notifications successfully received by a customer computing system to the amount of notifications a customer computing system failed to receive), average transmission speed (e.g., the average time between a notification being sent by operations computing system 140 and the notification being received by a responder), average user experience rating (e.g., a measure of user experience with a given communication technology based on factors such as feedback or user interaction with a notification), security rating (e.g., a measure of the security protocols, encryption standards, etc., used to transmit a notification), transmission capability rating (e.g., the abilities of a communication technology to transmit a notification, such as message size, multimedia capabilities, interactivity capabilities, etc.), and/or notification integrity rating (e.g., the ability of a notification to maintain content integrity between initial transmission and receipt by a responder). For instance, in one example, scoring engine 138 may determine a set of transmission ratings for a wireless communication technology associated with e-mail by, for example, analyzing information associated with one or more previous notifications transmitted to customer computing system 130A over e-mail. Scoring engine 138 may determine that the notification was successfully transmitted and that there was a 1.3 second period of time between the message being sent by operations computing system 140 and to be received by customer computing system 130A. Scoring engine 138 may determine, based on the metrics associated with other notifications sent over e-mail, that e-mail has transmission ratings including an average transmission speed of 1.9 seconds and an 85% success rate.

Scoring engine 138 may determine a score for each communication technology of the plurality of communication technologies. Scoring engine 138 may determine the score based on a set of transmission ratings associated with each communication technology of the plurality of communication technologies. For instance, operations computing system 140 may determine a score for a given communication technology based on transmission ratings associated with the communication technology, such as average delivery speed or success rate. For instance, in one example, operations computing system 140 may determine a score for e-mail based on the transmission ratings determined for e-mail. Scoring engine 138 may determine the transmissions ratings indicate e-mail is highly capable of transmitting a notification (e.g., a success rate over 90%), and, in turn, scoring engine 138 may score e-mail highly (e.g., a score of 8 or higher on a scale of 1-10). Conversely, scoring engine 138 may determine the transmissions ratings indicate e-mail is not well suited to transmit a notification (e.g., an average speed of more than 10 seconds), and, in turn, scoring engine 138 may score e-mail lowly (e.g., a score of 6 or lower on a scale of 1-10).

In some instances, scoring engine 138 may determine scores for communication technologies according to weights applied to various transmission ratings in the set of transmission ratings. Scoring engine 138 may assign weights to transmission ratings for communication technologies based on one or more factors related to an alert (e.g., the alert that triggered the creation of the notification). For instance, each alert may have different levels of urgency, priority, and severity, which may alter the goal of sending a notification. For instance, in one example, operations computing system 140 may determine that one or more alerts are high-priority, and that a responder may need to receive the one or more notifications as quickly as possible. Operations computing system 140 may set a preference for one or more communication technologies that have the highest delivery speed (e.g., to increase the speed at which responders receive the one or more notifications and assist responders in reducing system recovery time).

Scoring engine 138 may select one or more communication technologies from the plurality of communication technologies based on the score for each communication technology. For instance, scoring engine 138 may analyze three communication technologies of e-mail, SMS, and RCS, with scores of 8.3, 5.5, and 9.1, respectively. In some examples, scoring engine 138 may select just RCS. In other examples, scoring engine 138 may select multiple communication technologies, such as RCS and e-mail. Scoring engine 138 may inform notification engine 136 of the one or more communication technologies that were selected. In response, notification engine 136 may transmit, using the one or more communication technologies, the one or more notifications to responders for the customer computing system and associated with an alert. For instance, in one example, if notification engine 136 received an indication from scoring engine 138 to transmit the messages using e-mail, notification engine 136 may transmit the notification over e-mail to one or more on-call responders associated with the customer computing system the alert was raised on, such as responder computing devices 120A and customer computing system 110A, respectively.

In some examples, notification engine 136 may dynamically generate notifications according to the or more selected communication technologies. For instance, notification engine 136 may generate a notification according to features, specifications, protocols, or other capabilities associated with a selected communication technology. Notification engine 136 may be configured to obtain information associated with an alert based on a selected communication technology. For example, notification engine 136 may obtain information such as reports, logs, recommendations, or the like based on whether a selected communication technology may support including the information in a transmitted notification. Notification engine 136 may generate, based on the obtained information, a notification according to protocols, specifications, and/or features associated with the selected communication technology (e.g., generate a notification using obtained logs according to protocols associated with a messaging service communication technology). In some instances, notification engine 136 may alter the content of a notification according to the capabilities or features of the selected communication technologies (e.g., security levels, transmission integrity, user experience or user interface features, etc.). Similarly, notification engine 136 may create one or more interactive, graphical elements in a notification to automatically respond to the notification (e.g., status updates on the alert that triggered the notification, requests for more information, etc.). In this way, operations computing system 140 may decrease a recovery time associated with responding to an alert by utilizing various features of the selected communication technologies to provide additional information to responders.

FIG. 1 illustrates only one particular example of system 100. In the example of FIG. 1, system 100 might include all of the components shown in FIG. 1. However, in other examples, network system 100 may include a subset of the components included and/or may include additional components not shown in FIG. 1. Each of the computing systems illustrated in FIG. 1 (e.g., operations computing system 140 and customer computing systems 110) may represent any suitable computing system, such as one or more server computers, cloud computing systems, mainframes, appliances, desktop computers, laptop computers, mobile devices, and/or any other computing device that may be capable of performing operations in accordance with one or more aspects of the present disclosure. One or more of such systems may perform operations described herein as a result of instructions, stored on a computer-readable storage medium, executing on one or more processors. The instructions may be in the form of software stored on one or more local or remote computer readable storage devices. In other examples, one or more of such computing systems may perform operations using hardware, firmware, or a mixture of hardware, software, and firmware residing in and/or executing at each of such computing systems.

The techniques of the disclosure provide one or more technical advantages that realize one or more practical applications. For example, operations computing system 140 may dynamically determine which communication technology to transmit a notification based on various transmission ratings and scores to enhance the reliability of notification delivery to responders. Operations computing system 140 may improve success rates, transmission speeds, computational resource consumption, notification integrity, and/or user experience associated with transmitting a notification to a responder by selecting one or more communication technologies that have historical metrics indicating strong performance capabilities (e.g., high success rates, high delivery speeds, low resource usage, low downtime, high notification integrity, low costs, high user experience feedback, etc.). For instance, operations computing system 140 may select a communication technology based on a score for the communication technology indicating a high transmission success rate for a particular customer system or responder, to reduce a likelihood associated with retransmitting data for a notification to the particular customer system or responder. In this way, operations computing system 140 may reduce computing resource usage associated with retransmitting the data for the notification.

In some examples, operations computing system 140 may reduce time associated with responders addressing an alert of a system impacted by one or more operations events. For instance, operations computing system 140 may select a communication technology based on a score for the communication technology indicating a low downtime associated with responding to an alert (e.g., a score for a communication technology used to transmit a type of notification for a particular category or classification of the alert indicates a shorter downtime associated with a service or system impacted by a degradation event). In this way, operations computing system 140 may reduce recovery time to respond to operation events associated with a customer service or system by transmitting a notification for the alert to a responder using the selected communication technology.

In some examples, operations computing system 140 may select one or more communication technologies based on scores for the one or more communication technologies indicating efficient utilization of computational resources compared to one or more other communication technologies. For instance, operations computing system 140 may select a first communication technology over a second communication technology, when the first communication technology has marginally lower average transmission speeds, an equivalent success rate, and substantially lower computational resource usage than the second communications technology. Operations computing system 140 may improve utilization and/or reduce consumption of computational resources associated with transmitting and receiving notifications associated with alerts by selecting communication technologies with scores indicating lower computational resource usage.

In some examples, operations computing system 140 may further improve the reliability of notification delivery to responders through responder-based scoring, in accordance with one or more techniques of the current disclosure. For instance, operations computing system 140 may analyze the historical notification metrics related to the responder(s) receiving notifications. Operations computing system 140 may determine scores for communications technologies with respect to a specific set of responders (e.g., responders associated with a specific customer computing system, responders in a specific geographic region). Operations computing system 140 may determine a communication technology has a higher score with respect to the specific set of responders compared to other responders. As such, operations computing system 140 may transmit notifications to the specific set of responders using the highly scored communication technology to improve the speed or success rate of notification transmissions to the specific set of responders.

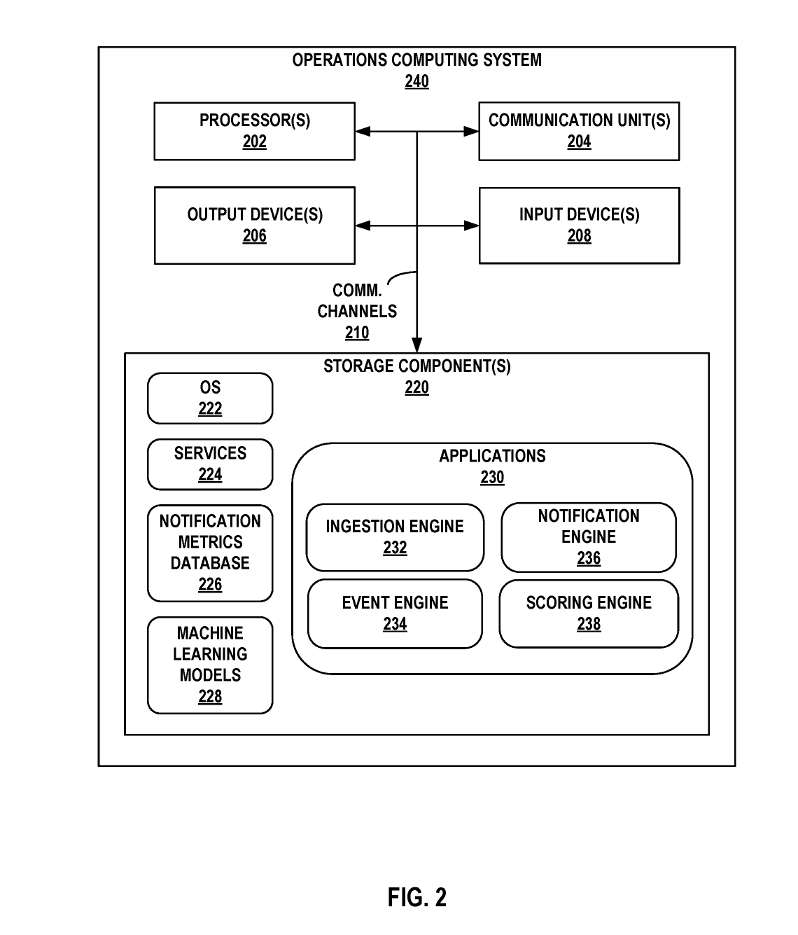

FIG. 2 is a block diagram illustrating an example operations computing system 240, in accordance with one or more aspects of the present disclosure. Operations computing system 240 may generally correspond to operations computing system 140 of FIG. 1. Notification engine 236, scoring engine 238, and notification metrics database 226 may generally correspond to, or be an alternative implementation of, notification engine 136, scoring engine 138, and notification metrics database 126, respectively. In the example of FIG. 2, operations computing system 240 may include one or more processors 202, one or more communication units 204, one or more output devices 206, one or more input devices 208, one or more communication channels 210, and one or more storage components 220. In the illustrated example, storage components 220 include operating system (OS) 222, services 224, notification metrics database 226, machine learning (ML) models 228 (hereinafter “ML models 228”), and applications 230. One or more of the devices, modules, storage areas, or other components of operations computing system 240 may be interconnected to enable intercomponent communications (physically, communicatively, and/or operatively).

Operations computing system 240 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, operations computing system 240 may comprise a server within a data center, cloud computing system, server farm, and/or server cluster (or portion thereof) that provides services to client devices and other devices or systems.

Although operations computing system 240 of FIG. 2 is illustrated as a stand-alone device, in other examples operations computing system 240 may be implemented in any of a wide variety of ways and may be implemented using multiple devices and/or systems. In some examples, operations computing system 240 may be, or may be part of, any component, device, or system that includes a processor or other suitable computing environment for processing information or executing software instructions and that operates in accordance with one or more aspects of the present disclosure. In some examples, operations computing system 240 may be fully implemented as hardware in one or more devices or logic elements.

Communication channels 210 may interconnect each of the components 202, 204, 206, 208, and/or 220 for inter-component communications (physically, communicatively, and/or operatively). In some examples, communication channels 210 may include a system bus, a network connection, an inter-process communication data structure, or any other method for communicating data. A power source (not shown) provides power to one or more components of operations computing system 240. In some examples, the power source may receive power from the primary alternative current (AC) power supply in a commercial building or data center, where some or all of an enterprise network may reside. In other examples, the power source may be or may include a battery.

One or more processors 202 of operations computing system 240 may implement functionality and/or execute instructions associated with operations computing system 240 associated with one or more modules illustrated herein and/or described below. One or more processors 202 may be, may be part of, and/or may include processing circuitry that performs operations in accordance with one or more aspects of the present disclosure. Examples of processors 202 include microprocessors, application processors, display controllers, auxiliary processors, one or more sensor hubs, and any other hardware configured to function as a processor, a processing unit, or a processing device. Operations computing system 240 may use one or more processors 202 to perform operations in accordance with one or more aspects of the present disclosure using software, hardware, firmware, or a mixture of hardware, software, and firmware residing in and/or executing at operations computing system 240.

One or more communication units 204 of operations computing system 240 may communicate with devices external to operations computing system 240 by transmitting and/or receiving data, and may operate, in some respects, as both an input device and an output device. In some examples, communication units 204 may communicate with other devices over a network. In other examples, communication units 204 may send and/or receive radio signals on a radio network such as a cellular radio network. In other examples, communication units 204 of operations computing system 240 may transmit and/or receive satellite signals on a satellite network such as a Global Positioning System (GPS) network. Examples of communication units 204 include a network interface card (e.g., such as an Ethernet card), an optical transceiver, a radio frequency transceiver, a GPS receiver, or any other type of device that may send and/or receive information. Other examples of communication units 204 may include devices capable of communicating over Bluetooth®, GPS, NFC, ZigBee, and cellular networks (e.g., 3G, 4G, 5G), and Wi-Fi® radios found in mobile devices as well as Universal Serial Bus (USB) controllers and the like. Such communications may adhere to, implement, or abide by appropriate protocols, including Transmission Control Protocol/Internet Protocol (TCP/IP), Ethernet, Bluetooth, NFC, or other technologies or protocols.

One or more input devices 208 may represent any input devices of operations computing system 240 not otherwise separately described herein. One or more input devices 208 may generate, receive, and/or process input from any type of device capable of detecting input from a human or machine. For example, one or more input devices 208 may generate, receive, and/or process input in the form of electrical, physical, audio, image, and/or visual input (e.g., peripheral device, keyboard, microphone, camera). For computing devices that may be used by a user, one or more input devices 208 may generate or receive input from a keyboard, pointing device, voice responsive system, video camera, button, sensor, mobile input device, control pad, microphone, presence-sensitive screen, network, or any other type of device for detecting input from a human or machine.

One or more output devices 206 may represent any output devices of operations computing system 240 not otherwise separately described herein. One or more output devices 206 may generate, receive, and/or process input from any type of device capable of detecting input from a human or machine. For example, one or more output devices 206 may generate, receive, and/or process output in the form of electrical and/or physical output (e.g., peripheral device, actuator). For computing devices that may be used by a user, one or more output devices 206 may generate, present, and/or process output in the form of tactile, audio, visual, video, and other output. Some devices may serve as both input and output devices. For example, a communication device may both send and receive data to and from other systems or devices over a network.

One or more storage components 220 within operations computing system 240 may store information for processing during operation of operations computing system 240. Storage components 220 may include one or more types of storage such as hard disk drives, solid state drives (e.g., SATA drives, NVMe drives, eMMC storage, etc.), magnetic tape drives, remote storage (e.g., cloud storage), and/or other types of storage. Storage components 220 may store program instructions and/or data associated with one or more of the modules described in accordance with one or more aspects of this disclosure. One or more processors 202 and one or more storage components 220 may provide an operating environment or platform for such modules, which may be implemented as software, but may in some examples include any combination of hardware, firmware, and software. One or more processors 202 may execute instructions and one or more storage components 220 may store instructions and/or data of one or more modules. The combination of processors 202 and storage components 220 may retrieve, store, and/or execute the instructions and/or data of one or more applications, modules, or software. Processors 202 and/or storage components 220 may also be operably coupled to one or more other software and/or hardware components, including, but not limited to, one or more of the components of operations computing system 240 and/or one or more devices or systems illustrated as being connected to operations computing system 240. In some examples, one or more storage components 220 are temporary memories, meaning that a primary purpose of the one or more storage components is not long-term storage. Storage components 220 of operations computing system 240 may be configured for short-term storage of information as volatile memory and therefore not retain stored contents if deactivated.

Examples of volatile memories include random access memories (RAM), dynamic random-access memories (DRAM), static random-access memories (SRAM), and other forms of volatile memories known in the art. Storage components 220, in some examples, also include one or more computer-readable storage media. Storage components 220 may be configured to store larger amounts of information than volatile memory. Storage components 220 may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories.

Storage components 220, as illustrated in FIG. 2, includes OS 222, services 224, notification metrics database 226, ML models 228, and applications 230. OS 222 may control the operation of components of operations computing system 240. For example, OS 222 may facilitate the communication of applications 230, ML models 228, and services 224, with processors 202, storage components 220, and communication units 204. OS 222 may have a kernel that facilitates interactions with underlying hardware of operations computing system 240 and provides a fully formed application space capable of executing a wide variety of software applications having secure partitions in which each of the software applications executes to perform various operations.

Services 224 may include one or more software components that generate computer-readable instructions, one or more microservices, computing devices, computing systems, or other pieces of computing infrastructure. Services 224 may be operated, managed, monitored, and/or configured by one or more teams associated with operations computing system 240. Services 224 may be employed by applications of applications 230s to process tasks or workflows generated by any of applications 230. In some instances, services of services 224 may assign tasks to other services of services 224.

Notification metrics database 226 may include information related to historical notification metrics. Historical notification metrics may include respective notification metrics associated with one or more previous notifications transmitted to a customer computing system (e.g., customer computing systems 110 of FIG. 1). Each of the one or more previous notifications may have been transmitted to the customer computing system using one communication technology from the plurality of communication technologies (e.g., the communication technology capabilities of operations computing system 240). For instance, notifications metrics database 226 may include information on one or more metrics related to the transmission of a notification, such as the speed (e.g., time from the notification being sent to the time the notification was received by the customer computing system) or success status of the notification. In some instances, notifications metrics database 226 may include information related to the content of a notification, such as the text of the notification or included multimedia content. In some instances, notifications metrics database 226 may include information related to one or more messages received from a responder in response to a notification. For example, notifications metrics database 226 may include information related to a message received from a user requesting more information about the alert specified in a notification.

In some examples, notification metrics database 226 may store one or more data structures, such as delivery reports or delivery receipts (DLRs), which may in turn include notifications metrics, such as the speed, success status, or content of a notification. For instance, in some examples, a delivery report may contain information such as the transmission status of the delivery of the notification (e.g., delivered, undelivered, pending, failed to deliver, etc.), the time stamp related to the sending of the message, the time stamp related to the delivery and/or receipt of the message, the content of the notification, or information about the receiving device (e.g., network information, device type and/or model, messing technology and/or application used to receive the message, etc.).

Operations computing system 240 may update notification metrics database 226 in response to the transmission of one or more notifications (e.g., in conjunction with notification engine 236 and communication units 204. In some examples, operations computing system 240 may update notification metrics database 226 with one or more values related to the historical notification metrics. In other examples, operations computing system 240 may update notification metrics database 226 with one or more delivery reports or an equivalent data structure.

Application 230 may include ingestion engine 232, event engine 234, notification engine 236, and scoring engine 238. Ingestion engine 232 may be arranged to receive and/or obtain one or more different types of operations events provided by various sources. Ingestion engine 232 may obtain operations events that include information regarding system errors, warnings, failure reports, customer service requests, status messages, or the like. Ingestion engine 232 may be configured to obtain operations events that may be variously formatted messages that reflect the occurrence of operation events that have occurred in and/or on a computing system of an organization (e.g., customer computing systems 110 of FIG. 1). Ingestion engine 232 may obtain operations events that may include SMS messages, HTTP requests or posts, API calls, log file entries, trouble tickets, emails, or the like. Ingestion engine 232 may obtain operations events that may be associated with one or more service teams that may be responsible for resolving issues related to the operations events. In some examples, ingestion engine 232 may obtain operations events from one or more external services that are configured to collect operations events. Ingestion engine 232 may send operations events to event engine 234.

Event engine 234 may be configured to orchestrate various actions related to analyzing operations events and determining alerts. Event engine 234 may orchestrate actions related to classifying operations events based on severity (e.g., critical, error, warning, information, unknown, etc.). Event engine 234 may orchestrate actions related to determining the severity of operations events. Event engine 234 may orchestrate actions related to determining a time frame or urgency for addressing an operations event. Event engine 234 may orchestrate actions related to prioritizing operations events for eventual processing. Event engine 234 may orchestrate actions related to identifying workflows or templates of actions that may be used to resolve certain operations events in an automated way. In some examples, event engine 224 may aggregate multiple alerts for a given operations event. For example, event engine 224 may determine a grouping as a collection of alerts of an alert group specifying a disruption to a service (e.g., computing services 115 of FIG. 1). In some examples, event engine 224 may be configured to trigger the transmission of a notification in response to receiving a single alert. In other examples, event engine 224 may be configured to trigger the transmission of a notification in response to determine an alert grouping (e.g., receiving multiple alerts connect to the same operations event).

Notification engine 236 may create one or more notifications in response to prompting from one or more of applications 230, such as scoring engine 238. Notification engine 236 may orchestrate actions of alerting or notifying teams of an operations event. Notification engine 236 may orchestrate actions related to notifying relevant computing systems of alerts. For instance, notification engine 236 may create one or more notifications that function as messages to one or more of responders providing information on a created alert. For instance, notification engine 236 may create a notification to include information associated with an alert, such as a unique identifier associated with the alert, status updates related to the alert (e.g., from event engine 234, from one or more of responders, etc.), the responders associated with the alert, an urgency level for the alert (e.g., as identified by ingestion engine 232), or identification information related to one or more services or resources (e.g., computing services impacted by a degradation event, a security threat, etc.) associated with the alert.

A notification may provide or operate as an interface for responders associated with the alert to interact with the alert (e.g., to update the alert with the current knowledge of the responder, to indicate that the responder is actively working on resolving issues associated with the alert, etc.). For example, one or more responders may respond to the notification with information related to the alert. In response to receiving a response, one or more of applications 230 may update an alert based on the received information from the one or more responders. A notification may be created in multiple formats (e.g., according to one or more communications technology that operations computing system 240, in conjunction with communications units 204, may transmit using). For instance, in one example, a notification may be an SMS message. In another example, a notification may be a push notification, such as from one or more applications (e.g., mobile applications, desktop applications, etc.).

In accordance with the techniques described herein, operations computing system 240 may determine a communication technology to transmit a notification to a customer system. Operations computing system 240 may determine a communication technology based on scores determined for a plurality of communication technologies. Scoring engine 238 may be configured to determine scores for a plurality of communication technologies (e.g., each communication technology that operations computing system 240 may use to transmit the notification) based on sets of transmission ratings. Scoring engine 238 may analyze data (e.g., historical notification metrics) stored in notification metrics database 226 to determine a set of transmission ratings for each communication technology in the plurality of communication technologies. For instance, to determine the set of transmission ratings for a specific communication technology, scoring engine 238 may locate all historical notification metrics in notification metrics database 226 related to the specific communication technology. A single historical notification metric may represent a single measurement of a communication technology with respect to a single notification. For instance, a historical notification metric may show that a communication technology transmitted a notification in 1.5 seconds. In general, scoring engine 238 may determine a set of transmission ratings for a communication technology by, for example, processing (e.g., aggregating, averaging, clustering, etc.) historical notification metrics associated with the communication technology.

Scoring engine 238 may perform a series of calculations on the set of all historical notification metrics related to the specific communication technology to determine the set of transmission ratings for the communication technology. The set of transmission ratings may include ratings such as average transmission resource usage (e.g., the average measurement of computing resources needed to transmit a notification, the average measurement of computing resources needed by a responder to receive a notification, a combination of the former and the latter, etc.), transmission success rate (e.g., the amount of notifications successfully received by a customer computing system to the amount of notifications a customer computing system failed to receive), average transmission speed (e.g., the average time between a notification being sent by operations computing system 240 and the notification being received by a responder), average user experience rating (e.g., a measure of user experience with a given communication technology based on factors such as feedback or user interaction with a notification), security rating (e.g., a measure of the security protocols, encryption standards, etc., used to transmit a notification), transmission capability rating (e.g., the abilities of a communication technology to transmit a notification, such as message size, multimedia capabilities, interactivity capabilities, etc.), and/or notification integrity rating (e.g., the ability of a notification to maintain content integrity between initial transmission and receipt by a responder). In one example, scoring engine 238 may locate historical notification metrics related to five notification transmissions over a specific communication technology. The historical notification metrics may indicate two 2 second deliveries, two 3 second deliveries, and one 4 second delivery. Scoring engine 238 may aggregate the data to determine that the communication technology has an average transmission speed of 3 seconds.

In some examples, scoring engine 238 may dynamically determine what historical notification metrics to generate transmission ratings from based on information related to the one or more customer systems related to the alert. For instance, in one example, scoring engine 238 may determine that the one or more responders a notification will be sent to (e.g., in response to the alert arising) may all operate within a specific geographic area. To obtain metrics that may provide insight on whether a specific set of communication technologies in the plurality of communication technologies operates differently (e.g., better, worse, etc.) within that geographic area in comparison to its overall operations, scoring engine 238 may evaluate historical notification metrics related to notifications sent to responders within the specific geographic area. Scoring engine 238 may determine that a communication technology, such as SMS, operates better within the geographic area than it does overall (e.g., a transmission success rate of 85% vs. 75%, an average transmission speed of 2.5 seconds vs. 3.1 seconds, etc.). In this way, scoring engine 238 may dynamically determine the historical notification metrics used to determine the set of transmission ratings to score and select communication technologies to transmit a notification.

Scoring engine 238 may determine a score for each communication technology of the plurality of communication technologies, based on the set of transmission ratings associated with each communication technology. For instance, scoring engine 238 may determine that the set of transmission ratings for a first communication technology indicates an average transmission speed of 2.5 seconds and a 75% success rate, while the set of transmission ratings for a second communication technology indicates an average transmission speed of 1.5 seconds and an 85% success rate. Scoring engine 238 may determine a score for each communication technology based on their associated set of transmission ratings. Scoring engine 238 may score the second communication technology higher than the first communication technology due to the increased success rate and faster average transmission speeds.

In some instances, scoring engine 138 may select a communication technology from a set of available communication technologies. For example, scoring engine 138 may determine a set of available communication technologies from the plurality of communication technologies by interacting with components of operations computing system 140, such as an operating system or set of communications units, to determine what communication technologies operations computing system 140 may use to transmit a notification. For instance, in one example, scoring engine 138 may determine that operations computing system 140 is unable to transmit messages over SMS (e.g., missing cellular modem, a down event for an SMS aggregator, etc.). Scoring engine 128 may exclude SMS from the set of available communication technologies. In some examples, the set of available communication technologies may be the plurality of communication technologies that scoring engine 138 may score.

Scoring engine 238 may dynamically determine various weights for one or more transmission ratings of the set of transmission ratings. For instance, in some examples, scoring engine 238 may determine weights for transmission ratings based on, for example, a notification ruleset associated with the customer system and/or a notification classification associated with the notification. A notification ruleset may determine how an individual responder (e.g., the responder associated with the impacted customer system) may be notified when an alert is assigned or otherwise associated with them. A notification ruleset may comprise responder-specific rules about the frequency at which a responder may be notified at, which communication technologies may be used to transmit one or more notifications, and which communication technologies may be preferred (with respect to one or more other communication technologies).

In some instances, a notification ruleset may allow a responder to set one or more rules that dynamically alter one or more other rules based on the urgency or severity of an alert associated with a notification. For instance, a responder may set up a default rule indicating a preference to receive notifications via e-mail as opposed to SMS, RCS, or voice. The responder may set up a secondary rule indicating that whenever an alert has a high-level of severity, the responder prefers to receive notifications related to the alert via SMS as opposed to e-mail, RCS, or voice. A notification classification associated with the notification may indicate whether the notification has a level of priority or urgency associated with it (e.g., due to the associated alert having a high priority, urgency, or severity level, as determined by event engine 234).

Based on the notification rulesets and notification classification, scoring engine 238 may dynamically determine weights for various transmission ratings of the set of transmission ratings. For instance, in one example, when a notification classification indicates a high level of priority, scoring engine 238 may assign a low weight (e.g., a low importance) to a transmission rating, such as average transmission resource usage, while increasing the weight of transmission ratings such as average speed or success rate, to increase the speed and likelihood of the notification being transmitted to a responder. Conversely, when a notification may be low priority, such as due to an the operations event that triggered an alert impacting a low-importance computing service, or pertaining only to low-impact services degradations, scoring engine 238 may assign a high weight to a transmission rating such as resource usage needed to transmit a notification, while decreasing the weight of transmission ratings such as average speed or success rate (e.g., to save resources). In another example, such as where the notification ruleset of a responder indicates they wish to receive as few notifications as possible, scoring engine 238 may weight a transmission rating, such as average transmission speed, slightly lower than another transmission rating, such as transmission success rate, to further emphasize the need to increase the likelihood of a first-try success (e.g., that the notification is successfully received by the responder on the first transmission attempt).

In some examples, scoring engine 238 may dynamically determine weights for a score for each communication technology, based on a notification ruleset associated with the customer system and/or a notification classification associated with the notification. For instance, a notification ruleset may indicate a preferential ordering of communication technologies for a responder, such as e-mail over SMS, SMS over voice, and voice over push. Scoring engine 238 may use the preferential ordering of communication technologies in the notification ruleset to assign a weight to the scores associated with each communication technology. For instance, scoring engine 238 may assign a higher weight to a communication technology associated with e-mail compared to a communication technology associated with SMS according to the preferences of the notification ruleset. In doing so, scoring engine 238 may adapt to user preferences. For instance, scoring engine 238 may determine a higher score for e-mail than for SMS after applying the weights, even in instances when SMS may have a marginally higher score pre-weighting. In some examples, scoring engine 238 may be configured to set the score for a given communication technology to zero. For instance, if the notification ruleset associated with the customer system indicates that the customer system cannot accept a notification transmitted using a specific communication technology (e.g., refuses to receive, lacks the capability to receive, etc.), scoring engine 238 may set the score for the communication technology to zero, so as to prevent notification engine 236 from transmitting the notification using the communication technology.

In some examples, operations computing system 240 may include ML models 228. ML models 228 may include one or more generative artificial intelligence (AI) models. For instance, one or more of ML models 228 may be transformer models, such as a Generative Pre-trained Transformer (GPT), Claude, BigScience Large Open-science Open-access Multilingual Language Model (BLOOM), Large Language Model Meta AI (LLaMA), Mistral 7B, or any other similar model known in the art. ML models 228 may be trained on information in notification metrics database 226. For instance, in one example, ML models 228 may process information related to a specific grouping or series of notification metrics, such as notification metrics related to notifications sent using a specific communications technology or notifications sent to customer systems in a specific geographic region.

ML models 228 may generate one or more predictions associated with the transmission of a notification over a specific communication technology. For instance, ML models 228 may generate a prediction, wherein the prediction relates to a predicted transmission rating, such as the predicted speed of a communication technology to transmit a notification. In some examples, scoring engine 238 may determine the score of each communication technology based in part on one or more predictions generated by one or more of ML models 228. For instance, in one example, scoring engine 238 may, in conjunction with other components of operations computing system 240, direct one or more of ML models 228 to generate predicted success rates for each communication technology as related to their ability to transmit to a customer system in a specific geographic region. Scoring engine 238 may include the predicted success rates in the set of transmission ratings that are used to determine the score for each communication technology.

Scoring engine 238 may generate a recommendation indicating a communication technology based on a prediction output by ML models 228. For instance, ML models 228 may generate one or more predictions related to a customer computing system (e.g., any of customer computing systems 110) and/or a responder (e.g., any of responder computing devices 120). In some examples, the one or more predictions may represent a transmission rating. For instance, ML models 228 may generate a prediction that a communication technology, such as e-mail, will have a transmission speed of 2.5 seconds. In accordance with the techniques of this disclosure, scoring engine 238 may apply the predictions when determining scores for communication technologies and selecting one or more communication technologies based on the scores. Scoring engine 238 may generate a recommendation that may be transmitted to a customer computing system and/or responder. Scoring engine 238 may generate a recommendation to include a set of communication technologies that scoring engine 238 determines has high predicted scores associated with transmitting notifications to the customer computing system and/or responder. The recommendation may inform the customer computing system and/or responder to update one or more notification configurations and/or systems in order to receive notifications over the recommended communication technologies.

Scoring engine 238 may select one or more communication technologies from the plurality of communication technologies, based in part on the score of each communications technology. For instance, in one example, scoring engine 238 may select a communication technology from the plurality of communication technologies with a higher score than other communication technologies. In other examples, scoring engine 238 may select one or more communication technologies from the plurality of communication technologies with a score based on scores for the one or more communication technologies satisfying a specific threshold. For instance, scoring engine 238 may select one or more communication technologies from the plurality of communication technologies with a score of at least 8 (e.g., on a scale of 0-10).

Scoring engine 238 may inform notification engine 236 of the one or more communications technologies that were selected. Notification engine 236, in conjunction with other components of operations computing system 240, such as communication units 204, may generate and transmit the notification, based on the one or more communications technologies that were selected. In some examples, notification engine 236 may generate a notification according to content attributes associated with a selected communication technology. For example, in instances where scoring engine 238 selects a communication technology associated with protocols for transmitting larger volumes of data, notification engine 236 may generate a notification to include an allowable volume of information associated with an alert (e.g., report logs, response recommendations, updates, potential causes for degradation events, etc.) in a notification transmitted using the selected communication technology. In another example, in instances where scoring engine 236 selects a communication technology associated with a limited character limit for notifications (e.g., SMS), notification engine 236 may employ ML models 228 to generate a summary of an alert according to the limited character limit associated with the selected communication technology.

In some examples, the notification may include interactive components that a responder may utilize to communicate with operations computing system 240. For example, in instances where scoring engine 238 selects a communication technology associated with interactive components (e.g., WhatsApp, iMessages, etc.), notification engine 236 may generate interactive UI components (e.g., buttons, sliders, forms, selectors, etc.) that a user may interact with (e.g., click on, drag, slide, select, type in, etc.). In some examples, when a user interacts with a component, notification engine 236 may, in conjunction with event engine 234, update information related to one or more alerts. For instance, a responder may interact with a component generated by notification engine 236 to resolve (e.g., close, delete, mark as read, etc.) an alert. When notification engine 236 receives an indication that the responder interacted with the component, notification engine 236 and event engine 234 may update the alert accordingly. In other examples, when a user interacts with a component, notification engine 236 may generate one or more secondary notifications that may be transmitted to the responder. For instance, in one example, a responder may interact with a component generated by notification engine 236 to receive more information on an alert. Notification engine 236 may generate a second notification containing additional information on the alert. Notification engine 236 may transmit the second notification over the communication technology that was used to transmit the initial notification. In this way, notification engine 236 may dynamically generate notifications according to features, protocols, and/or specifications (e.g., selectable response features, message polling features, content attributes, compliance standards, etc.) associated with selected communication technologies.

In some examples, scoring engine 238 may generate a notification transmission configuration, based on the one or more communications technologies that were selected. The notification transmission configuration may represent a set of rules associated with notification engine 236 transmitting notifications. For instance, scoring engine 238 may generate the notification transmission configuration to include an ordering of the one or more communication technologies that were selected. Scoring engine 238 may generate the notification transmission configuration to indicate an order for the one or more communication technologies based on the score of each communication technology. In some examples, scoring engine 238 may generate the notification transmission configurations to include rules for the transmission of one or more communication technologies in the one or more communication technologies. For instance, scoring engine 238 may generate notification transmission configuration to include a rule that notification engine 236 should transmit the notification using the first item in the notification transmission configuration. In some examples, scoring engine 238 may generate notification transmission configurations to include a rule that, in instances where a given communication technology fails to transmit (e.g., a delivery receipt indicates the message was not successfully delivered, a delivery receipt is never received, etc.), or fails to transmit in a given amount of time, notification engine 236 may transmit the notification using the next communication technology in the notification transmission configuration. In some examples, scoring engine 238 may generate notification transmission configurations to include a rule for notification engine 236 to send the notification until it receives a delivery receipt or other response that indicates the notification was successfully delivered to the customer system.

In some examples, scoring engine 238 may set a default notification transmission configuration based on the one or more communications technologies that were selected. For instance, in one example, scoring engine 238 may set default notification transmission configurations to indicate a communication technology (e.g., the first communication technology in a notification transmission configuration ordering of communication technologies) based on scoring engine 238 determining a high score for the communication technology for a specific customer system. In another example, scoring engine 238 may set default notification transmission configurations to indicate a notification transmission configuration (e.g., ordering of communication technologies) specific to a customer system. Notification engine 236 may be configured to transmit future notifications to the customer system according to the default notification transmission configuration.

In some examples, scoring engine 238 may request permission from one or more users (e.g., responders) associated with the customer system prior to setting the default notification transmission configuration. For instance, scoring engine 238, in conjunction with other components of operations computing system 240, may present the one or more users with the default notification transmission configuration in one or more user interfaces (e.g., an application managed by the organization responsible for managing operations computing system 240, through one or more messages, such as an e-mail or SMS, etc.). Scoring engine 238 may receive indications (e.g., a user input) associated with notification transmission configurations via one or more users interacting with the one or more user interfaces (e.g., accepting, denying, or alerting the notification transmission configurations). In some examples, scoring engine 238 may update notification transmission configurations according to indications associated with one or more users editing notification transmission configuration via the one or more user interfaces (e.g., edit an ordering of communication technologies, edit a timing threshold for moving onto another communication technology in the ordering of communication technologies, etc.). If accepted, scoring engine 238 may update notification transmission configurations used by notification engine 236 to transmit notifications to the customer system.

FIG. 2 illustrates only one particular example of operations computing system 240. In the example of FIG. 2, operations computing system 240 might include all of the components shown in FIG. 2. However, in other examples, operations computing system 240 may include a subset of the components included or may include additional components not shown in FIG. 2. Operations computing system 240 may represent any suitable computing system, such as one or more server computers, cloud computing systems, mainframes, appliances, desktop computers, laptop computers, mobile devices, and/or any other computing device that may be capable of performing operations in accordance with one or more aspects of the present disclosure. One or more of such systems may perform operations described herein as a result of instructions, stored on a computer-readable storage medium, executing on one or more processors. The instructions may be in the form of software stored on one or more local or remote computer readable storage devices. In other examples, one or more of such computing systems may perform operations using hardware, firmware, or a mixture of hardware, software, and firmware residing in and/or executing at each of such computing systems.

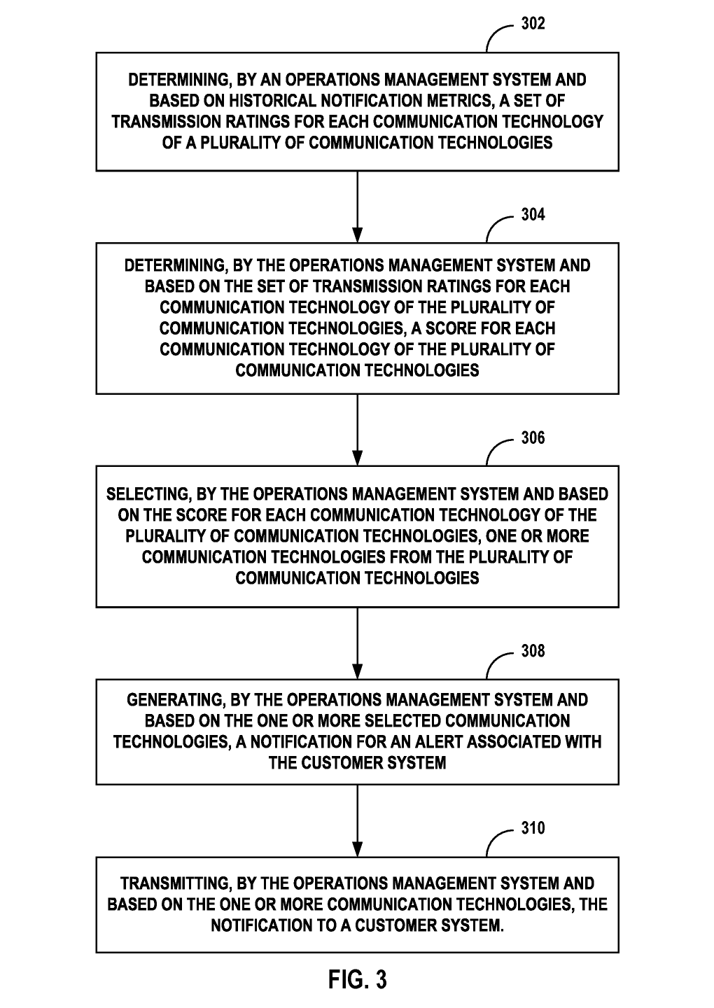

FIG. 3 is a flow diagram illustrating example operations of dynamically transmitting one or more notifications to a customer system, in accordance with one or more techniques of this disclosure. FIG. 3 is described below within the context of operations computing system 240 of FIG. 2. In other examples, operations described in FIG. 3 may be performed by one or more other components, modules, systems, or devices. Further, in other examples, operations described in connection with FIG. 3 may be merged, performed in a different sequence, omitted, or may encompass additional operations not specifically illustrated or described.

In the process illustrated in FIG. 3, and in accordance with one or more aspects of the present disclosure, operations computing system 240 determines, based on historical notification metrics, a set of transmission ratings for each communication technology of a plurality of communication technologies (302). For example, operations computing system 240 may, in conjunction with OS 222, cause components of operations computing system 240, such as scoring engine 238, to interact with one or more databases, such as notification metrics database 226, that include metrics associated with one or more notifications, such as the transmission speed or delivery status of a notification. The historical notification metrics include respective notification metrics associated with one or more previous notifications transmitted to a customer system. Each of the one or more previous notifications was transmitted to the customer system using one communication technology from the plurality of communication technologies.

Operations computing system 240 determines, based on the set of transmission ratings for each communication technology of the plurality of communication technologies, a score for each communication technology of the plurality of communication technologies (304). Operations computing system 240 selects, based on the score for each communication technology of the plurality of communication technologies, one or more communication technologies from the plurality of communication technologies (306). Operations computing system 240 generates a notification for an alert based on the selected communication technology (308). For instance, operations computing system 240, in conjunction with OS 222, causes components of operations computing system 240, such as notification engine 236, to generate the notification based on factors related to the selected communication technology, such as data payload size. Operations computing system 240 transmits, based on the one or more communication technologies, a notification to the customer system (310). For example, operations computing system 240, in conjunction with OS 222, causes components of operations computing system 240, such as notification engine 236 and communications units 204, to create and transmit a notification to the customer system over the one or more communication technologies.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

For ease of illustration, a limited number of devices or systems are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each illustrate at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the Figures and/or may include additional devices and/or components not shown in the Figures.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In accordance with one or more aspects of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structures or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is:

1. A method comprising:
determining, by an operations management system and based on historical notification metrics, a set of transmission ratings for each communication technology from a plurality of communication technologies, wherein the historical notification metrics include respective notification metrics associated with one or more previous notifications transmitted to a customer system, and wherein each of the one or more previous notifications was transmitted to the customer system using one communication technology from the plurality of communication technologies;
determining, by the operations management system and based on the set of transmission ratings for each communication technology of the plurality of communication technologies, a score for each communication technology of the plurality of communication technologies;
selecting, by the operations management system and based on the score for each communication technology of the plurality of communication technologies, one or more communication technologies from the plurality of communication technologies;
generating, by the operations management system and based on the one or more selected communication technologies, a notification for an alert associated with the customer system; and
transmitting, by the operations management system and based on the one or more communication technologies, the notification to the customer system.

2. The method of claim 1, further comprising determining, by the operations management system, the historical notification metrics based on respective transmission statuses indicated in delivery receipts associated with transmitting the one or more previous notifications.

3. The method of claim 1, further comprising setting, by the operations management system and responsive to a user input, a notification transmission configuration based on the one or more communication technologies.

4. The method of claim 1, wherein the plurality of communication technologies includes at least two of Short Message Service (SMS), Rich Communication Service (RCS), electronic mail (e-mail), or a mobile application.

5. The method of claim 1, wherein the set of transmission ratings for each communication technology indicate at least one of average transmission resource usage, transmission success rate, or average transmission speed.

6. The method of claim 1, wherein determining the score for each communication technology comprises:
assigning, by the operations management system, one or more weights to one or more transmission ratings of the set of transmission ratings based at least on a notification ruleset associated with the customer system and a notification classification associated with the notification; and
determining, by the operations management system and based on the one or more weights assigned to the one or more transmission ratings, a score for each communication technology of the plurality of communication technologies.

7. The method of claim 1, wherein determining the score comprises determining the score further based on one or more predictions generated by one or more machine learning (ML) models.

8. The method of claim 7, wherein the one or more ML models are trained to generate the one or more predictions at least in part on the historical notification metrics.

9. The method of claim 1, wherein selecting the one or more communication technologies comprises generating, by the operations management system, notification transmission configurations indicating an order associated with the one or more communication technologies.

10. The method of claim 9, wherein transmitting the notification comprises transmitting, by the operations management system, the notification, based on the order indicated in the notification transmission configurations.

11. A system comprising:
a memory; and
one or more processors having access to the memory, wherein the one or more processors are configured to:
determine, based on historical notification metrics, a set of transmission ratings for each communication technology of a plurality of communication technologies, wherein the historical notification metrics include respective notification metrics associated with one or more previous notifications transmitted to a customer system, and wherein each of the one or more previous notifications was transmitted to the customer system using one communication technology from the plurality of communication technologies;
determine, based on the set of transmission ratings for each communication technology of the plurality of communication technologies, a score for each communication technology of the plurality of communication technologies;
select, based on the score for each communication technology of the plurality of communication technologies, one or more communication technologies from the plurality of communication technologies;
generate, based on the one or more selected communication technologies, a notification for an alert associated with the customer system; and
transmit, based on the one or more communication technologies, the notification to the customer system.

12. The system of claim 11, wherein the one or more processors are further configured to determine the historical notification metrics based on respective transmission statuses indicated in delivery receipts associated with transmitting the one or more previous notifications.

13. The system of claim 11, wherein the one or more processors are further configured to set, responsive to a user input, a notification transmission configuration based on the one or more communication technologies.

14. The system of claim 11, wherein to determine the score for each communication technology, the one or more processors are configured to:
assign one or more weights to one or more transmission ratings of the set of transmission ratings based at least on a notification ruleset associated with the customer system and a notification classification associated with the notification; and
determine, based on the one or more weights assigned to the one or more transmission ratings, a score for each communication technology of the plurality of communication technologies.

15. The system of claim 11, wherein to determine the score, the one or more processors are further configured to determine the score further based on one or more predictions generated by one or more machine learning models.

16. The system of claim 15, wherein the one or more machine learning models are trained to generate the one or more predictions at least in part on the historical notification metrics.

17. The system of claim 11, wherein to select the one or more communication technologies, the one or more processors are further configured to generate notification transmission configurations indicating an order associated with the one or more communication technologies.

18. The system of claim 17, wherein to transmit the notification, the one or more processors are further configured to transmit the notification based on the order indicated in the notification transmission configurations.

19. A non-transitory computer-readable storage medium encoded with instructions that, when executed, cause at least one processor of a computing system to:
determine, based on historical notification metrics, a set of transmission ratings for each communication technology of a plurality of communication technologies, wherein the historical notification metrics include respective notification metrics associated with one or more previous notifications transmitted to a customer system, and wherein each of the one or more previous notifications was transmitted to the customer system using one communication technology from the plurality of communication technologies;
determine, based on the set of transmission ratings for each communication technology of the plurality of communication technologies, a score for each communication technology of the plurality of communication technologies;
select, based on the score for each communication technology of the plurality of communication technologies, one or more communication technologies from the plurality of communication technologies;
generate, based on the one or more selected communication technologies, a notification for an alert associated with the customer system; and
transmit, based on the one or more communication technologies, the notification to the customer system.

20. The computer-readable storage medium of claim 19, wherein to determine the score for each communication technology, the at least one processor is further configured to:
assign one or more weights to one or more transmission ratings of the set of transmission ratings based at least on a notification ruleset associated with the customer system and a notification classification associated with the notification; and
determine, based on the one or more weights assigned to the one or more transmission ratings, a score for each communication technology of the plurality of communication technologies.
